(19) United States
(12) Patent Application Publication
(10) Pub. No.: US 2003/0109976 A1
(43) Pub. Date: Jun. 12, 2003

(54) Human-powered vehicle control method using forecasting power calculation

(75) Inventors: Huai-Ching Chien, Hsinchu (TW); Ching-Huan Tseng, Hsinchu (TW)

Correspondence Address: BROWDY AND NEIMARK, P.L.L.C., 624 NINTH STREET, NW, SUITE 300, WASHINGTON, DC, 20001-5303, US

(73) Assignee: Falcon Industrial Co., Ltd., Taichung Hsien (TW)

(21) Appl. No.: 10/155,024

(22) Filed: May 28, 2002

(30) Foreign Application Priority Data
Dec. 6, 2001 (TW) 90130184

(51) Int. Cl. G06F 19/00

(52) U.S. Cl. 701/51; 280/238

(57) ABSTRACT

A control method of a transmission system in a human-powered vehicle based on a forecasting comfortable power consumption and a comfortable cadence is provided in this invention to supply a comfortable travel for a controller of a human-powered vehicle. This control method includes the steps of sensing a traveling distance in one past period and an inclination. Then the controller may forecast a comfortable power consumption in the virtual period and calculate a forecasting traveling distance in the virtual period from the forecasting power consumption. Afterward, controller may calculate a forecasting optimum gear ratio from the forecasting traveling distance and a comfortable cadence and may generate control signals to the transmission system in the human-powered vehicle. The transmission system in the human-powered vehicle then automatically adjust its gear ratio to the forecasting optimum gear ratio or automatically choose an existing gear ratio which is most close to the forecasting optimum gear ratio.

### FIELD OF THE INVENTION

The present invention relates to a control method of a transmission system in a human-powered vehicle and, more particularly, to a control method of shifting a bicycle transmission system using a forecasting comfortable power consumption and a comfortable cadence.

### BACKGROUND OF THE INVENTION

Automatic gear shifting in a bicycle can be achieved by the mechanical method or the electrical method. For example, in U.S. Pat. No. 6,135,907, U.S. Pat. No. 5,957,797, U.S. Pat. No. 5,618,240, U.S. Pat. No. 5,514,041, U.S. Pat. No. 5,407,396, U.S. Pat. No. 5,199,929, U.S. Pat. No. 5,163,881, U.S. Pat. No. 5,033,991, U.S. Pat. No. 4,781,663, U.S. Pat. No. 4,741,546, U.S. Pat. No. 4,713,042, U.S. Pat. No. 4,701,152, U.S. Pat. No. 4,599,079, U.S. Pat. No. 4,598,920, U.S. Pat. No. 4,571,219, U.S. Pat. No. 4,352,503, U.S. Pat. No. 3,929,025 and U.S. Pat. No. 3,926,020, automatic gear shifting is achieved by the mechanical method. Most of these inventions sense a rider's peak force, a chain tension, or a centrifugal force on the rear wheel by a mechanical sensing apparatus. Then a shifting apparatus actuates derailleur chain-shifting mechanism to guide chain corresponding to the sensed rider's peak force, chain tension, or the centrifugal force on the rear wheel. The advantages of these inventions are the very high accuracy control and very short reaction time. However, the sensing apparatus and shifting apparatus are always complex and hard to couple to a general type bicycle.

On the other head, most sensors utilized within an automatic electrical gear shifting in a bicycle are cheap and easy to couple to a general type bicycle, except the torque sensor. Most inventions about automatic electrical gear shifting in a bicycle sense the biking velocity, biking acceleration, cadence, angular acceleration of the crank, torque, torque variation about time, inclination, tension to the chain, or the effort from the rider. Then a controller or a computer calculates an optimum gear ratio or determines a better neighbor gear ratio from the sensed signals, and sends control signals to a shifting apparatus. Afterward, the shifting apparatus actuates derailleur chain-shifting mechanism to guide chain corresponding to the control signals. For example, in U.S. Pat. No. 6,146,297, U.S. Pat. No. 6,073,061 and U.S. Pat. No. 5,900,705, the controller senses the biking velocity to be the control factor, and then calculates an optimum gear ratio. In other publications, such as U.S. Pat. No. 5,728,017, U.S. Pat. No. 5,538,477, U.S. Pat. No. 5,356,348, U.S. Pat. No. 5,254,044, U.S. Pat. No. 5,213,548 and U.S. Pat. No. 5,059,158, the controller senses the cadence to be the control factor, and then determines a better neighbor gear ratio. In U.S. Pat. No. 5,551,315 and U.S. Pat. No. 4,490,127 the controller senses the biking velocity and the cadence to be the control factors, and then determines a better neighbor gear ratio. In U.S. Pat. No. 5,261,858, the controller senses the biking velocity and the cadence to be the control factors too, however, it calculates an optimum gear ratio. In U.S. Pat. No. 6,015,159, the controller senses the biking velocity and the torque to be the control factors, and then determines a better neighbor gear ratio. In U.S. Pat. No. 5,571,056, the controller senses the cadence and the torque to be the control factors, and then determines a better neighbor gear ratio. In U.S. Pat. No. 4,605,240, the controller senses the biking velocity and the inclination to be the control factors, and then calculates an optimum gear ratio. In U.S. Pat. No. 6,047,230, the controller senses the biking velocity, cadence and the tension on the chain to be the control factors, and then determines a better neighbor gear ratio. In U.S. Pat. No. 5,266,065, the controller senses the biking velocity, biking acceleration, torque and inclination to be the control factors, and then calculates an optimum gear ratio. In other applications, such as U.S. Pat. No. 5,681,234 and U.S. Pat. No. 5,599,244, the controller senses the cadence, angular acceleration of the crank, torque and torque variation about time to be the control factors, and then determines a better neighbor gear ratio.

One of the disadvantages of these inventions about an automatic electrical gear shifting in a bicycle is that all of the inventions can not completely represent the biking behavior from their sensed signals. So the better neighbor gear ratio or the optimum gear ratio calculated by a controller or a computer is not a real better or optimum gear ratio in some situations such as accelerating, decelerating, uphill or downhill. Therefore, rider may feel uncomfortable in such situations.

### SUMMARY OF THE INVENTION

The present invention relates to a control method of a transmission system in a human-powered vehicle and, more particularly, to a control method of shifting a bicycle transmission system using a forecasting comfortable power consumption and a comfortable cadence. The controller senses a traveling distance in one past period as well as an inclination, and then derives a biking velocity and biking acceleration for calculating the power input to the bicycle, or the power output from the rider. The power consumed by road friction can be derived from a derived biking velocity, a predetermined mass, and a predetermined road resistance coefficient. The power consumed by the system inertia can be derived from a derived biking velocity, acceleration and a predetermined mass. The power consumed by gravity can be derived from a predetermined mass and an inclination. The power consumed by the air friction can be derived from a derived biking velocity, a predetermined or sensed wind velocity, a predetermined system area facing the air, a predetermined air density and a predetermined air dynamic coefficient.

In one embodiment of the present invention, once the controller senses a traveling distance in one past period, it derives an average biking velocity in this past period. For a predetermined or a learned forecasting power consumption which may supply a comfortable travel for the individual rider, the controller then may calculate a forecast traveling distance in a current virtual period from a derived biking velocity, a predetermined mass, inclination, predetermined road resistance coefficient, predetermined air dynamic coefficient, predetermined air density, predetermined system area facing the air, predetermined or sensed wind velocity, such that the biking system consumes a predetermined or a learned value in this current virtual period. If the biking system moves the forecasting traveling distance in a current virtual period, the rider may feel comfortable. In other words, if the rider accelerates the biking system to the forecast biking velocity in a current virtual period, the rider may feel comfortable. After a forecasting comfortable traveling distance is determined, the controller divides the traveling distance with the time of the current virtual period as well as a predetermined or learned comfortable cadence to derive a forecasting optimum gear ratio. Finally, the controller may send an indicating signal to the actuating system to cause a gear shifting to the forecasting optimum gear ratio or to an existing gear ratio which is most close to the forecasting optimum gear ratio.

In another embodiment of the present invention, the power consumed by road friction or air friction can be neglected in the calculation of a forecasting comfortable traveling distance depending on the calculating ability of the controller. Thus, the controller then may calculate a forecast traveling distance in a current virtual period only from a derived biking velocity, predetermined mass and an inclination, such that the biking system consumes a predetermined or a learned value in this current virtual period. This may substantially decrease the calculating time of a controller.

### BRIEF DESCRIPTION OF THE DRAWINGS

FIG. 1 is a comfortable situation curve according to a comfortable power exported equation of the present invention;

FIG. 2 is a flow chart illustrating processing steps of a preferred embodiment to operate a controller in a human-powered vehicle according to the present invention;

FIG. 3 is a graph of velocity, acceleration and gear ratio versus time in an accelerating situation according to the present invention;

FIG. 4 is a graph of velocity, acceleration and gear ratio versus time in an uphill situation according to the present invention; and

FIG. 5 is a graph of velocity, acceleration and gear ratio versus time in a downhill situation according to the present invention.

### DETAILED DESCRIPTION OF THE INVENTION

There are three hypotheses used to develop the control principle of automatic derailleur system. The first one is adopted from “Bicycle Science”, Frank Rowland, Whitt, Parid Gordon, Wilson, MIT Press, 1990. It was said that a normal manhood rider could export 0.1 horsepower for about 1 hour. So the first hypothesis is obtained that a rider could feel comfortable if he keeps his power exported constant.

The proper power exported depends on different riders. Since the power exported from rider is equal to the power spent by the biking system, a comfortable power exported P_{comfort} is defined as follows,

$${P}_{comfort} = \frac{{C}_{v}}{{η}_{mech}} \{ \sum mg [ {C}_{R} + \frac{s}{100} + \frac{a}{g} ( 1 + \frac{{m}_{w}}{\sum m} ) ] + 0.5 {C}_{D} A {ρ ( {C}_{v} + {C}_{W} )}^{2} \} \qquad Eq . ( 1 )$$

In this equation, Cᵥ and a are the corresponding biking velocity and acceleration while rider export P_{comfort} at any instant, and η_{mech}, C_{R}, S, m_{w}, C_{D}, A, ρ and C_{W} are the mechanical efficiency, road resistance coefficient, inclination, rotary parts mass, air resistance coefficient, system area facing the air, air density and wind velocity respectively.

The second hypothesis is adopted from the theory of Prof. Hsiao National Ching-Hua University of Taiwan, R. O. C. in 2000. He claimed that keeping ω_{crank} a constant would make the rider feels comfortable. Considering a motor or engine, the efficiency of them depends on the load and the rotation speed. For any load applying on the motor or engine, there is always a rotation speed that makes the motor or engine performs a highest efficiency. Human maybe have the same characteristic as the motor or engine. This assumption leads into the second hypothesis which says that human rider feels most comfortable under a specific power output P_{crank} if he keeps his ω_{crank} as a specific constant corresponding to the specific P_{crank}.

The third hypothesis describes the adaptability of riders. While riding a bicycle with discrete transmission system, it is hard for a rider to choose a completely fit gear ratio to make him feels comfortable. On the other hand, it can be easily achieved while riding a bicycle with continuous transmission system theoretically. Therefore, a rider only can choose an acceptable but not the best gear ratio while riding a bicycle with discrete transmission system. After the rider chooses one acceptable gear ratio, he can slightly modulate his output to let him feels comfortable.

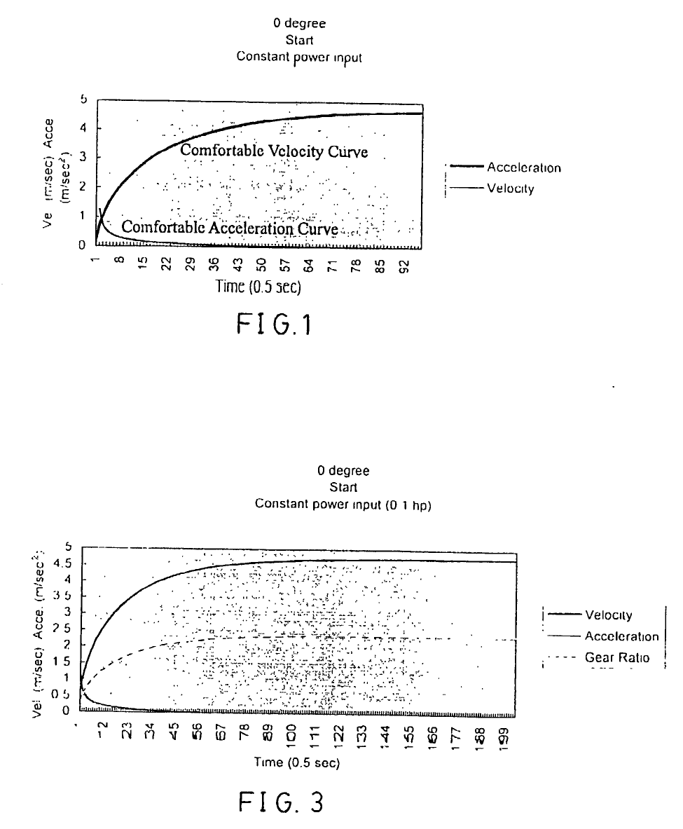

In accordance with the first hypothesis and Eq. (1), a comfortable situation curve can be generated as shown in FIG. 1.

The comfortable velocity curve and comfortable acceleration curve in FIG. 1 are sketched out based on the rule described below. At any time instant, the biking system moves in a velocity of Cᵥ and acceleration a. Substitute Cᵥ and a at this time instant into Eq. (1) and set P_{comfort} for the rider's riding habit, then Cᵥ and a at next time instant can be solved. Here Cᵥ and a are the velocity and acceleration that the biking system has better be if the rider wants to ride comfortably. However, they are not those the biking system has to be since it is possible that the rider wants to slow down or fasten the system in an uncomfortable situation.

According to the opinion of comfortable situation curve, the control principle of automatic derailleur system is generated. First an assumption is made that the rider wants to ride comfortably in the next time period. Then the corresponding Cᵥ and a at next time instant are derived from Eq. (1). One thing has to be mentioned here is that the controller needs to calculate Cᵥ and a at every time instant based on Cᵥ and a at the moment. This is because that the biking system often substantially or slightly deviates the original comfortable situation curve generated at the beginning of the riding process.

Now the problem is how to choose a gear ratio to make rider accelerate to Cᵥ in acceleration a along a comfortable situation curve. After the proper P_{comfort} to each type of gear shifting subsystem in each riding situation in Eq. (1) is confirmed, the corresponding Cᵥ and a that the biking system will be at next time instant if the rider wants to ride comfortably can be derived from Eq. (1). Theoretically, many gear ratios can make the biking system achieve Cᵥ in acceleration a, but not all of them make the rider feel comfortable. Only few of them are acceptable by the rider, and only one fit the rider most.

Now the second hypothesis is utilized to choose a proper gear ratio to arrange in pairs with this Cᵥ and a. Since the load P_{comfort} at the next time instant is fixed, there should be a proper ω_{crank} that makes rider feel most comfortable. The ω_{crank} corresponding to specific P_{comfort} varies among different riders and needs to be trained by the intelligent controller. After Cᵥ, a and ω_{crank} are derived by calculating and table consulting, count the gear ratio R as below.

$$R = \frac{\frac{{C}_{v}}{π \times {D}_{wheel}}}{{ω}_{crank}} \qquad Eq . ( 2 )$$

Since most of the transmission systems used on bicycle nowadays are discrete systems, the controller has to find a pair of gears that their gear ratio is most near to that R derived in Eq. (2). Theoretically speaking, there is a gap between the gear ratio of the chosen pair of gears and the calculated R. By the third hypothesis, rider can slightly modulate his output for this chosen pair of gears to let him feel comfortable.

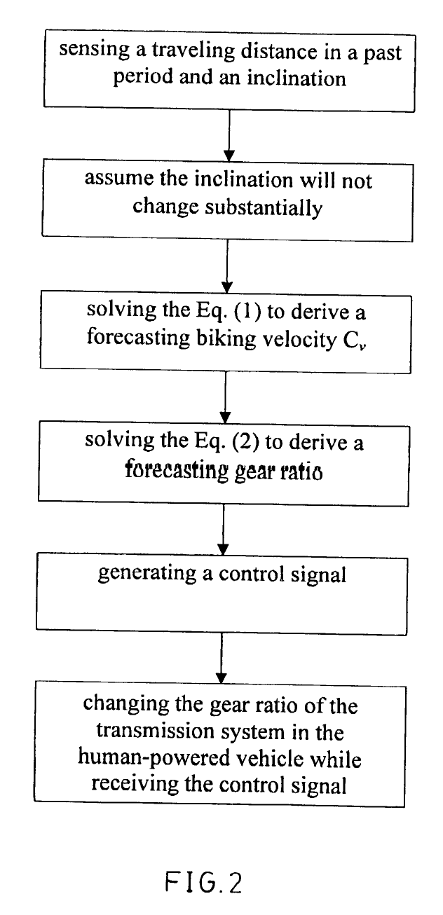

As shown in FIG. 2, the present invention obtains the biking velocity Cᵥ from Eq. (1), then calculate the gear ratio R from Eq. (2), and then generating a control signal and sending the control signal to a controller to change the gear ratio of the transmission system in the human-powered vehicle.

In another embodiment of the present invention, the power consumed by road friction or air friction can be neglected for saving the calculating time such that the Eq. (1) can be further amended as follows.

$$\begin{matrix}\begin{matrix}{P}_{comfort} = \frac{{C}_{v}}{{η}_{mech}} \{ \sum mg [ {C}_{R} + \frac{s}{100} + \frac{a}{g} ( 1 + \frac{{m}_{w}}{\sum m} ) ] \} \\ \end{matrix} & Eq . ( 3 ) \\ \begin{matrix}{P}_{comfort} = \frac{{C}_{v}}{{η}_{mech}} \{ \sum mg [ \frac{s}{100} + \frac{a}{g} ( 1 + \frac{{m}_{w}}{\sum m} ) ] \} \\ \end{matrix} & E q . ( 4 )\end{matrix}$$

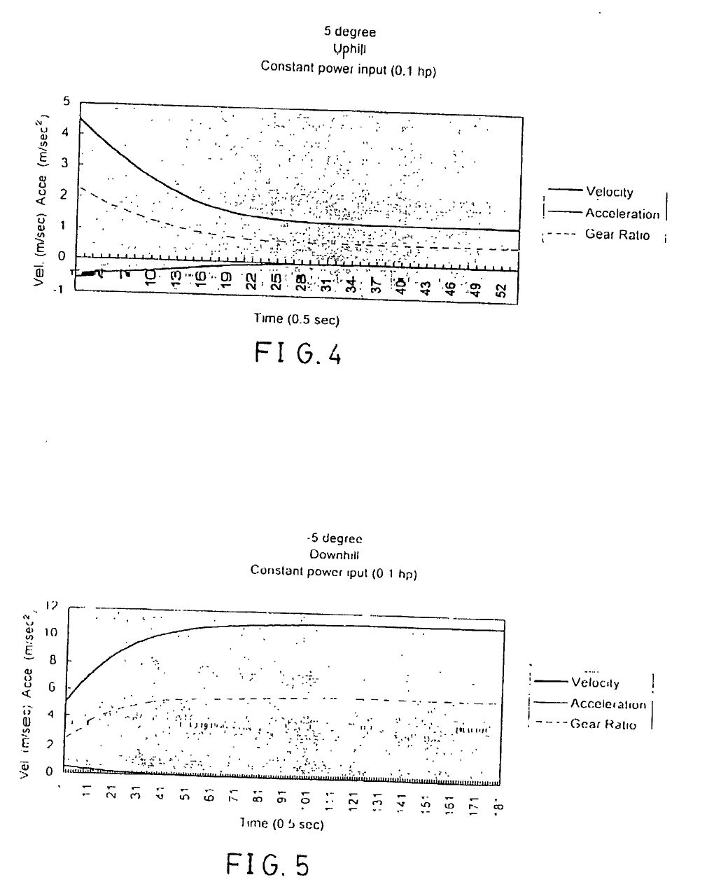

FIGS. 3-5 show the relationships of the velocity, acceleration and gear ratio when the vehicle is in acceleration situation, traveling uphill and downhill.

What is claimed is:

1. A method of operating a controller in a human-powered vehicle comprising the steps of:
determining a forecasting traveling distance in a current virtual period from a traveling distance in a past period and an inclination;
determining a forecasting gear ratio from the forecasting traveling distance and a cadence; and
generating a control signal.

2. The method according to claim 1 further comprising the steps of:
sensing the traveling distance in the past period;
sensing the inclination; and
transferring the sensed traveling distance and inclination into the controller.

3. The method according to claim 1 wherein the forecasting traveling distance determining step further comprising the steps of:
determining a forecasting power consumption in the current virtual period; and
determining the forecasting traveling distance based on the forecasting power consumption.

4. The method according to claim 1 wherein the forecasting gear ratio determining step further comprising the steps of:
determining the cadence in the current virtual period; and
determining the forecasting gear ratio from the forecasting traveling distance and the cadence.

5. The method according to claim 1, wherein the forecasting traveling distance in the current virtual is determined from the traveling distance in the past period, the inclination and a road friction.

6. The method according to claim 5 further comprising the steps of:
sensing the traveling distance in the past period;
sensing the inclination;
determining the road friction; and
transferring the sensed traveling distance and inclination into controller.

7. The method according to claim 5 wherein the forecasting traveling distance determining step further comprising the steps of:
determining a forecasting power consumption in the current virtual period; and
determining the forecasting traveling distance based on the forecasting power consumption.

8. The method according to claim 5 wherein the forecasting gear ratio determining step further comprising the steps of:
determining a cadence in the current virtual period; and
determining the forecasting gear ratio from the forecasting traveling distance and the cadence.

9. The method according to claim 5, wherein the forecasting traveling distance in the current virtual is determined from the traveling distance in the past period, the inclination, the road friction and an air friction.

10. The method according to claim 9 further comprising the steps of:
sensing the traveling distance in the past period;
sensing the inclination;
determining the road friction;
determining the air friction; and
transferring the sensed traveling distance and inclination into the controller.

11. The method according to claim 9 wherein the forecasting traveling distance determining step further comprising the steps of:
determining a forecasting power consumption in the current virtual period; and
determining the forecasting traveling distance based on the forecasting power consumption.

12. The method according to claim 9 wherein the forecasting gear ratio determining step further comprising the steps of:
determining a cadence in the current virtual period; and
determining the forecasting gear ratio from the forecasting traveling distance and the cadence.

13. A method of operating a transmission system in a human-powered vehicle comprising the steps of:
determining a forecasting traveling distance in a current virtual period from a traveling distance in a past period and an inclination;
determining a forecasting gear ratio from the forecasting traveling distance and a cadence; and
changing the gear ratio of the transmission system in the human-powered vehicle based on the forecasting gear ratio.

14. The method according to claim 13 further comprising the steps of:
sensing the traveling distance in the past period;
sensing the inclination; and
transferring the sensed traveling distance and inclination into a controller of the human-powered vehicle.

15. The method according to claim 13 wherein the gear ratio changing step further comprising the steps of:
generating a control signal; and
changing the gear ratio of the transmission system in the human-powered vehicle while receiving the control signal.

16. The method according to claim 13, wherein the forecasting traveling distance in the current virtual is determined from the traveling distance in the past period, the inclination and a road friction.

17. The method according to claim 16 further comprising the steps of:
sensing the traveling distance in the past period;
sensing the inclination; and
transferring the sensed traveling distance and inclination into a controller of the human-powered vehicle.

18. The method according to claim 16 wherein the gear ratio changing step further comprising the steps of:
generating a control signal; and
changing the gear ratio of the transmission system in the human-powered vehicle while receiving the control signal.

19. The method according to claim 16, wherein the forecasting traveling distance in the current virtual is determined from the traveling distance in the past period, the inclination, the road friction and an air friction.

20. The method according to claim 19 further comprising the steps of:
sensing the traveling distance in the past period;
sensing the inclination; and
transferring the traveling distance and inclination into a controller of the human-powered vehicle.

21. The method according to claim 19 wherein the gear ratio changing step further comprising the steps of:
generating a control signal; and
changing the gear ratio of the transmission system in the human-powered vehicle while receiving the control signal.
